(19) United States
(12) Patent Application Publication
(10) Pub. No.: US 2015/0275952 A1
(43) Pub. Date: Oct. 1, 2015

(54) PLUG-ON PART FOR A PLUG CONNECTOR

(71) Applicant: FRITZ STEPPER GMBH & CO. KG, Pforzheim (DE)

(72) Inventor: Fritz STEPPER, Pforzheim (DE)

(73) Assignee: FRITZ STEPPER GMBH & CO. KG, Pforzheim (DE)

(21) Appl. No.: 14/224,513

(22) Filed: Mar. 25, 2014

(51) Int. Cl. F16B 17/00

(52) U.S. Cl. CPC F16B 17/00

(57) ABSTRACT

The invention relates to a plug-on part for a plug connector (1), comprising a sleeve-like basic body (11) manufactured by deforming a strip of material (13) having two longitudinal edges (15a, 15b) and two transverse edges and by connecting the longitudinal edges (15a, 15b).

According to the invention, a surface (14d) of the strip of material (13) having the first longitudinal edge (15a) comprises at least a first locking element (21a, 21b; 71) and a further surface (14a) of the strip of material (13) having the second longitudinal edge (15b) comprises a further locking element (23a, 23b; 73) complementary to the first locking element (21a, 21b; 71); and the connection of the longitudinal edges (15a, 15b) of the strip of material (13) to form the sleeve-like basic body (11) is performed by cooperating locking elements (21a, 21b; 73).

The invention relates to a plug-on part for a plug connector comprising a sleeve-like basic body manufactured by deforming a strip of material having two longitudinal edges and two transverse edges and by connecting the longitudinal edges.

Such a plug-on part for a plug connector is known. To form the sleeve-like basic body, the strip of material is deformed until the two longitudinal edges of the strip of material are facing each other. The connection thereof to form the sleeve-like basic body is then performed by a welding process, in particular laser welding. Such laser welding requires intensive investments and costs, since a complex device has to be integrated in the production process to carry out the laser welding of the two longitudinal edges.

It is an object of the present invention, to further develop a plug-on part as mentioned above, so that a connection of the longitudinal edges of the strip of material to form the sleeve-like basic body is possible in a simple way.

The object is achieved in that a surface of the strip of material having the first longitudinal edge comprises at least a first locking element and a further surface of the strip of material having the second longitudinal edge comprises a further locking element complementary to the first locking element, and that the connection of the longitudinal edges of the strip of material to form the sleeve-like basic body is performed by cooperating locking elements.

The measures according to the invention advantageously provide the connection of the two longitudinal edges of the strip of material forming the sleeve-like basic body and thus the surfaces having these by means of mechanical connections which are easy to manufacture. The manufacturing of plug-on parts according to the invention requires no investment-consuming devices, such as a laser welding station, so that a plug-on part according to the invention distinguishes itself by its cost-effective manufacturing. This is of great advantage especially for mass products as they constitute such plug-on parts. Another advantage is that the plug-on part according to the invention is not subject to any thermal influence during its manufacturing and thus also not subject to any thermally induced deformations or the like. Thus, a high degree of precision fit is achievable with a simple manufacturing process.

An advantageous embodiment of the invention provides that the mechanical connection of the longitudinal edges of the strip of material forms the sleeve-like basic body by at least one latching connection. Such a measure has the advantage that the inventive plug-on part for a plug connector is particularly easy to manufacture.

A further advantageous embodiment of the invention provides that the mechanical connection of the two longitudinal edges of the strip of material is formed by at least one shear nose and an opening in the strip of material cooperating with each other. Such measure has the advantage that the plug-on part according to the invention provides a high security lock.

A further advantageous embodiment of the invention provides that the mechanical connection of the two longitudinal edges of the strip of material is formed by at least one shear flap, which engages a notch in the strip of material. Such measure has the advantage that such a shear flap and the thereto complementary notch are particularly easy to manufacture.

A further advantageous embodiment of the invention provides that the plug-on part for the plug connector provides a fixing element by which the formed mechanical connection of the two cooperative locking elements is secured against unintentional loosening. Such measure has the advantage that the thus formed plug-on part on the plug connector distinguishes itself by large closure stability, as the fixing member provided in the opening of the side surface according to the invention supports the above lying locking element of the top surface and thus counteracts an unintended loosening of the mechanical connection between the corresponding surfaces of the plug-on element.

A further advantageous embodiment of the invention provides that the mechanical connection of the two longitudinal edges of the strip of material is formed by at least one recess in the side surface and a projection of the top surface engaging this recess. This configuration of the plug-on element according to the invention distinguishes itself by large closure stability, as the bottom of the recess provided in the side surface, according to the invention, supports the projection projecting from the top surface and thus counteracts an unintended loosening of the such provided mechanical connection.

Further advantageous embodiments of the invention are subject matter of dependent claims.

Further advantageous embodiments of the invention are presented in the embodiments described by the figures. There is shown:

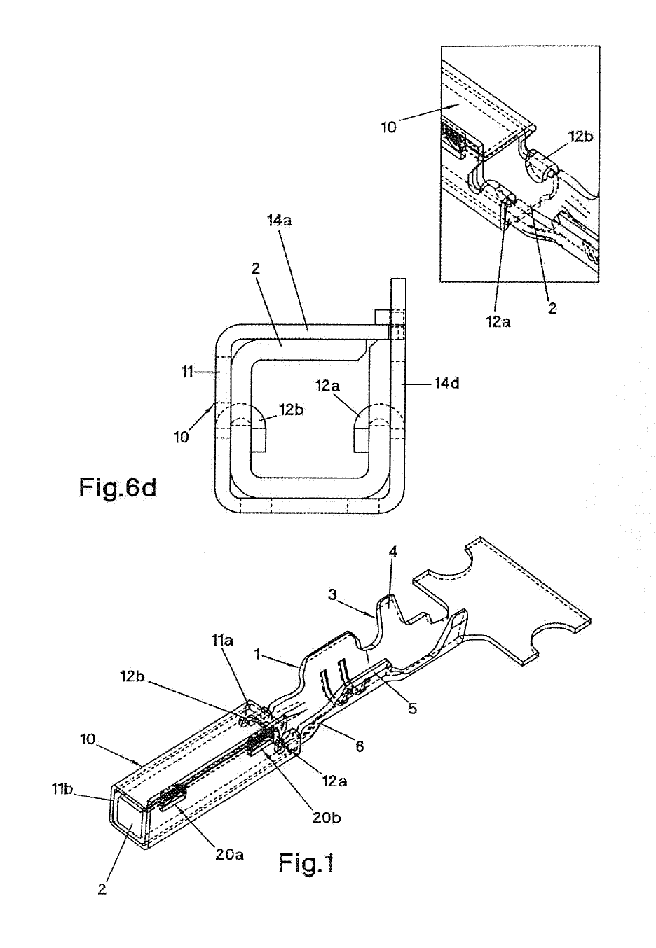

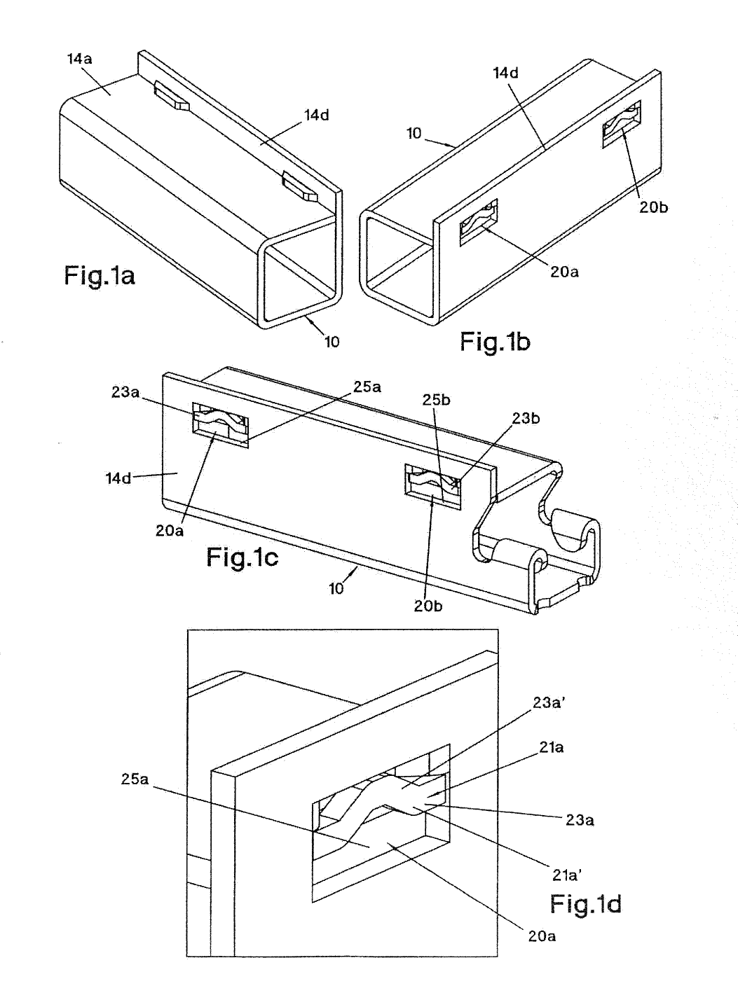

FIG. 1: perspective views of a plug connector with a first embodiment of a plug-on part;

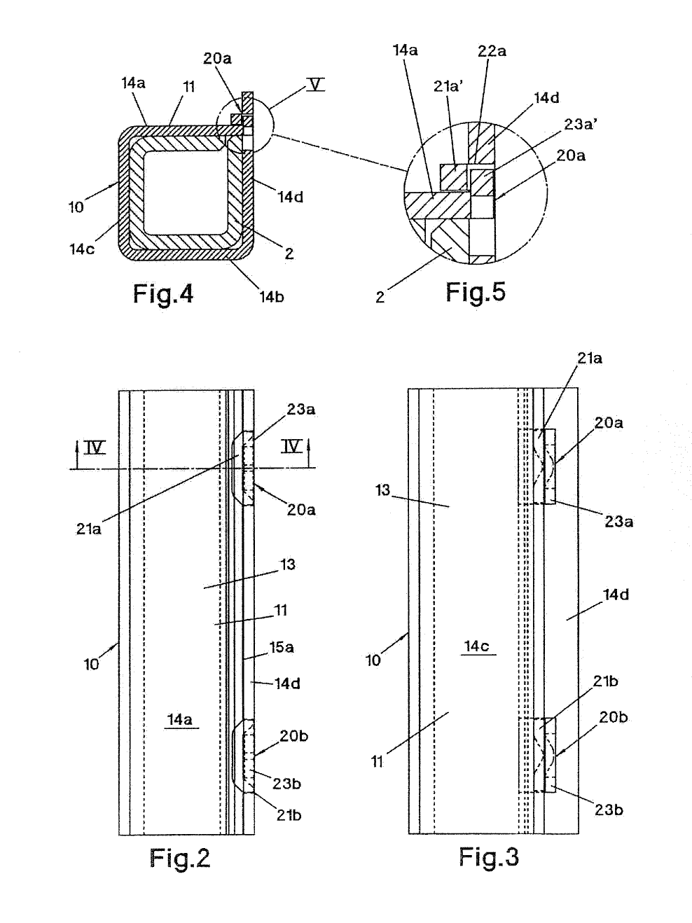

FIG. 2: top view of the first embodiment;

FIG. 3: side view of the first embodiment;

FIG. 4: sectional view along line IV-IV of FIG. 2;

FIG. 5: enlarged view of region V of FIG. 4;

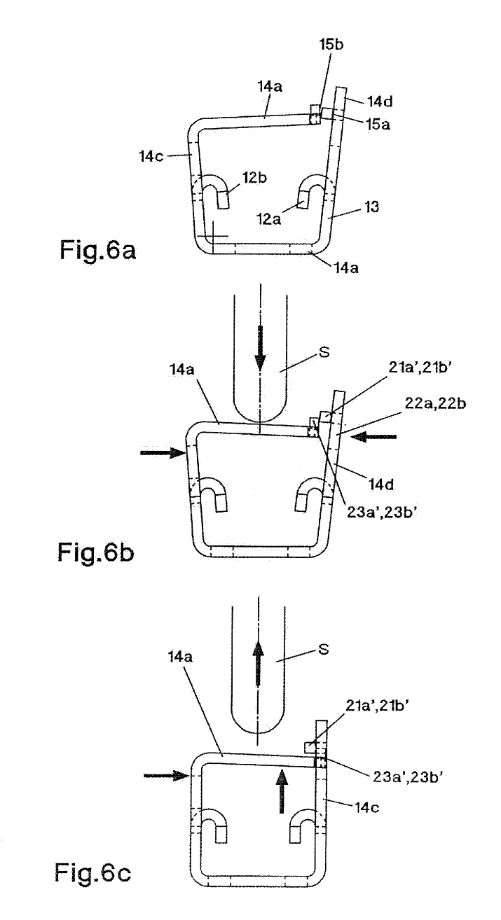

FIG. 6: schematic view of the manufacturing of the plug-on part according to the first embodiment;

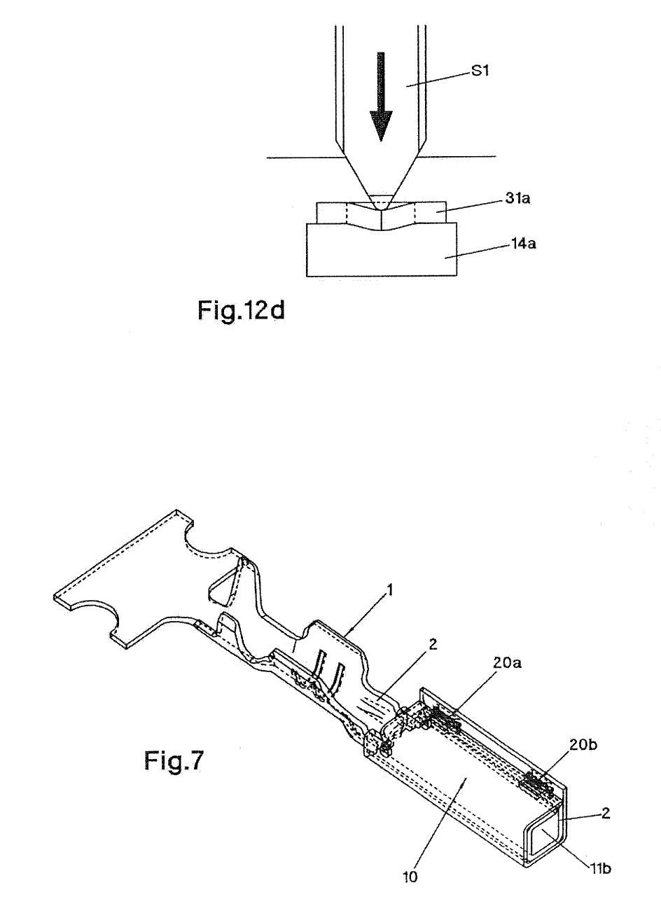

FIG. 7: perspective views of a plug connector with a second embodiment of the plug-on part;

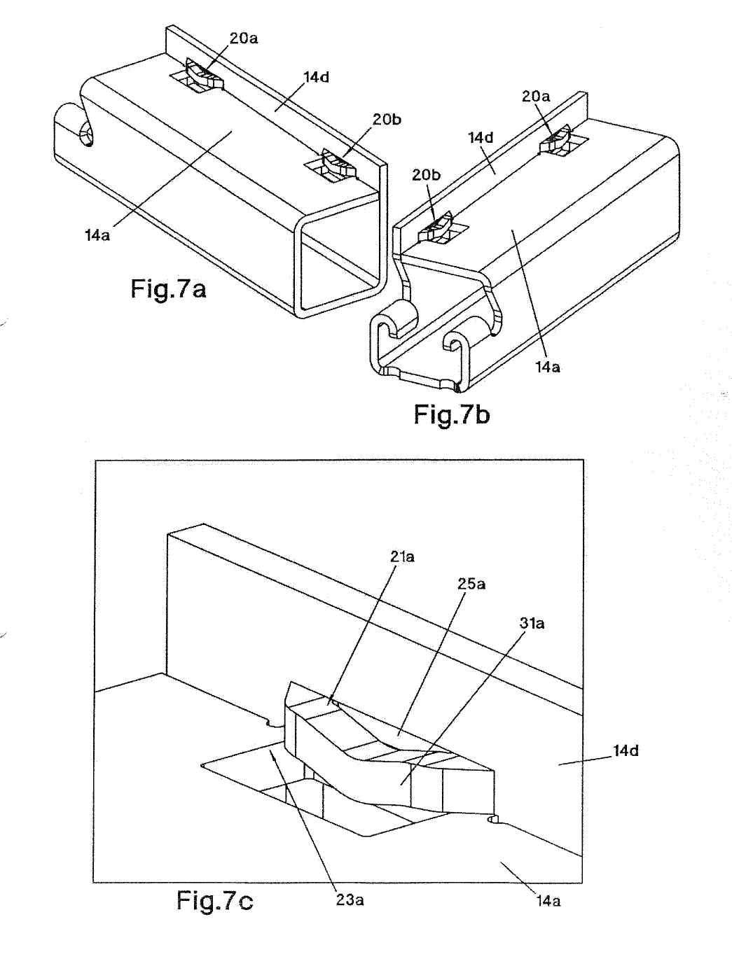

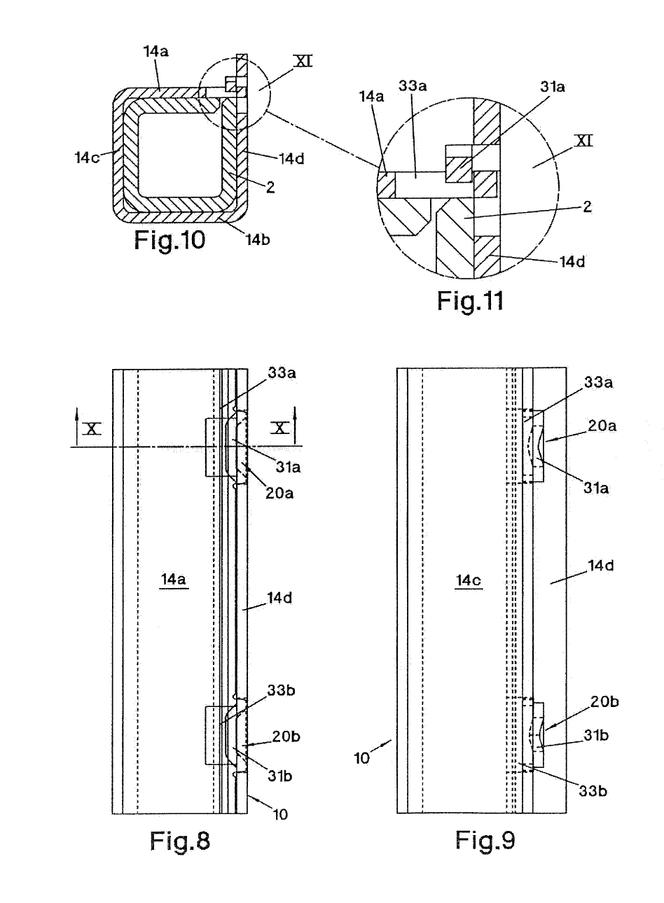

FIG. 8: top view of the second embodiment;

FIG. 9: side view of the second embodiment;

FIG. 10: sectional view along line X-X of FIG. 8;

FIG. 11: enlarged view of region XI of FIG. 10;

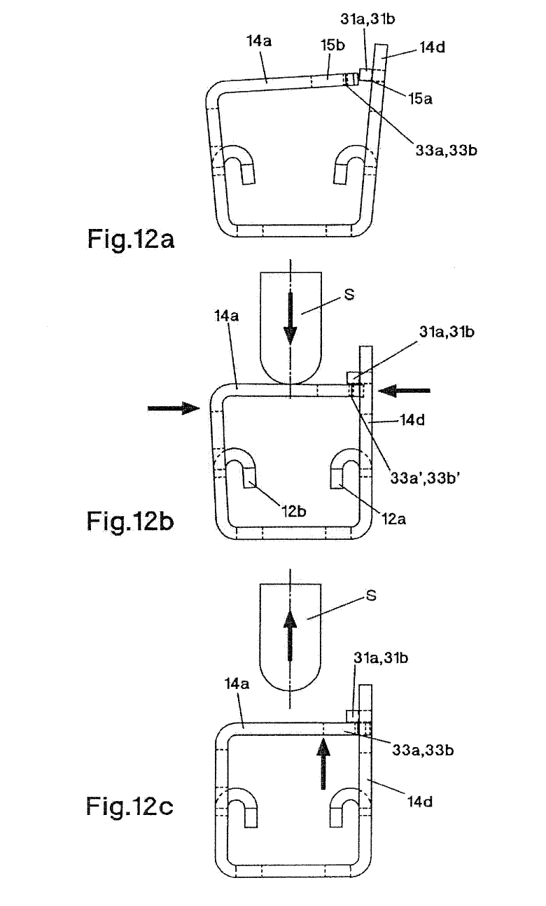

FIG. 12: schematic view of the manufacturing of the plug-on part according to the second embodiment;

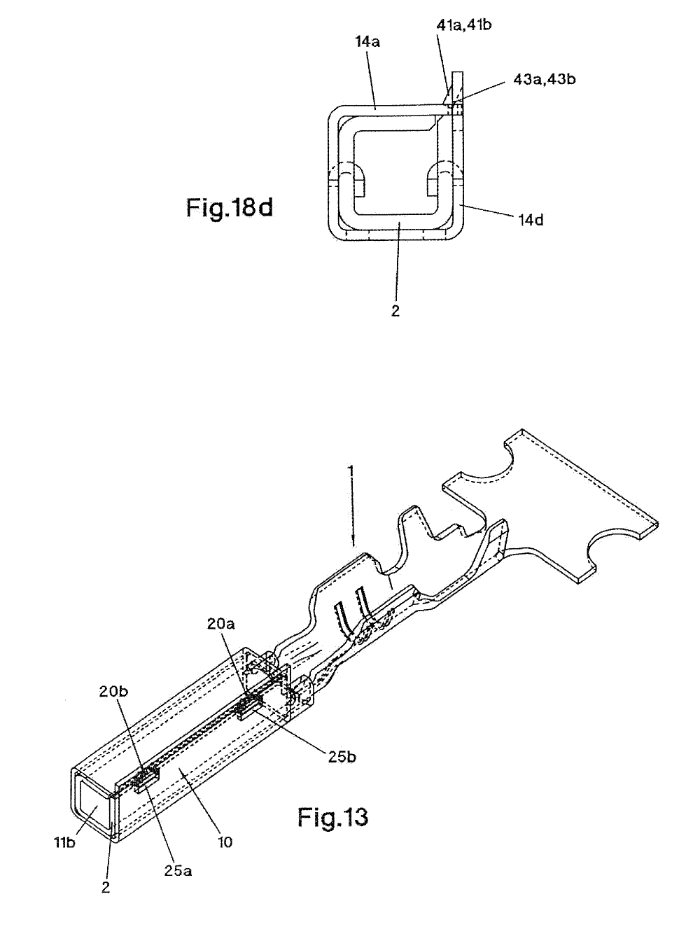

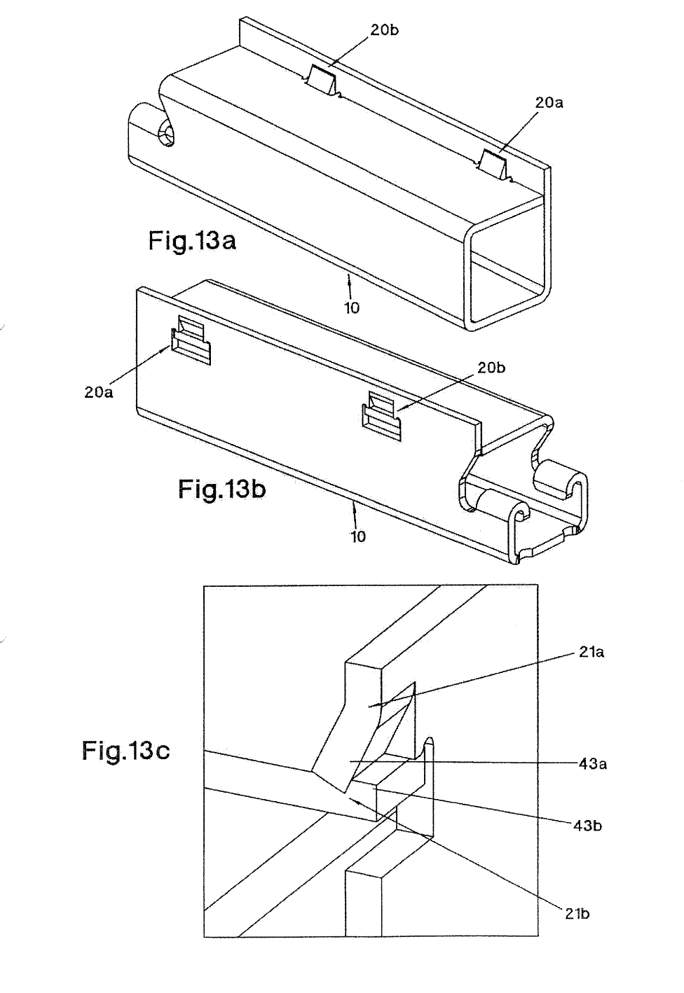

FIG. 13: perspective views of the plug connector with a third embodiment of a plug-on part;

FIG. 14: top view of the third embodiment;

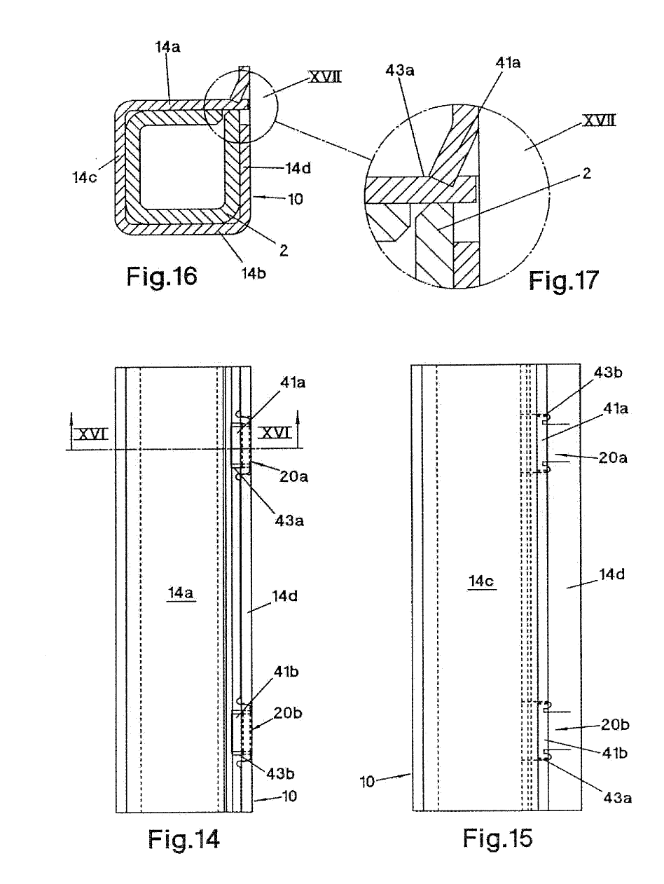

FIG. 15: side view of the third embodiment;

FIG. 16: sectional view along line XVI-XVI of FIG. 14;

FIG. 17: enlarged view of portion XVII of FIG. 16;

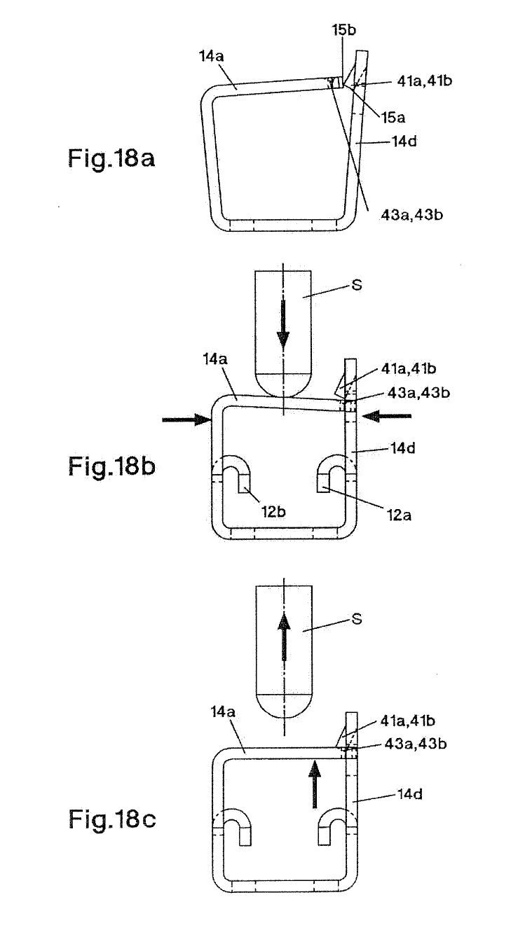

FIG. 18: schematic view of the manufacturing of the plug-on part according to the third embodiment;

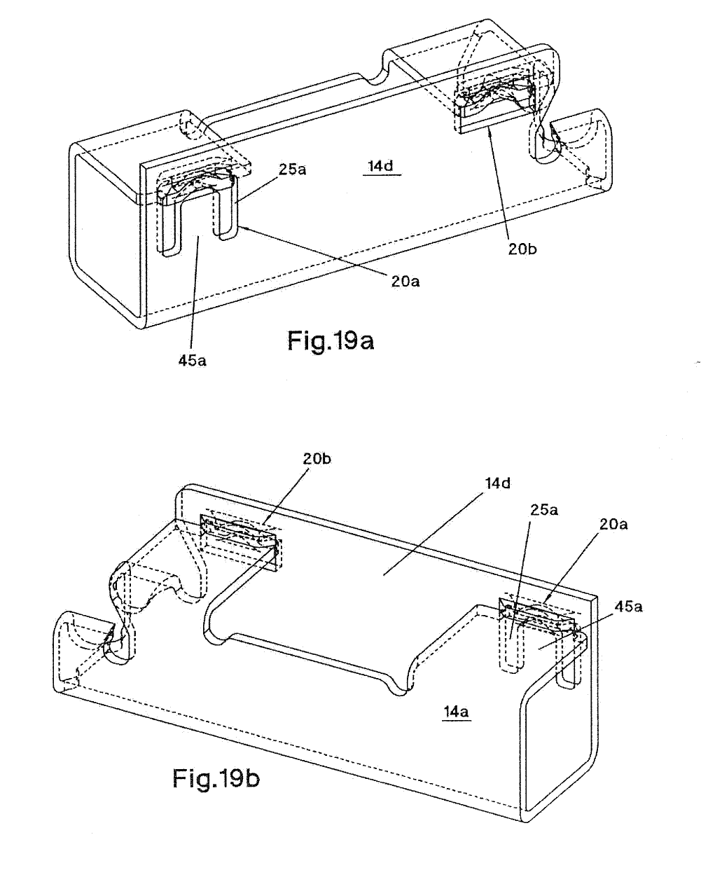

FIG. 19: perspective views of a fourth embodiment of a plug-on part for a plug connector;

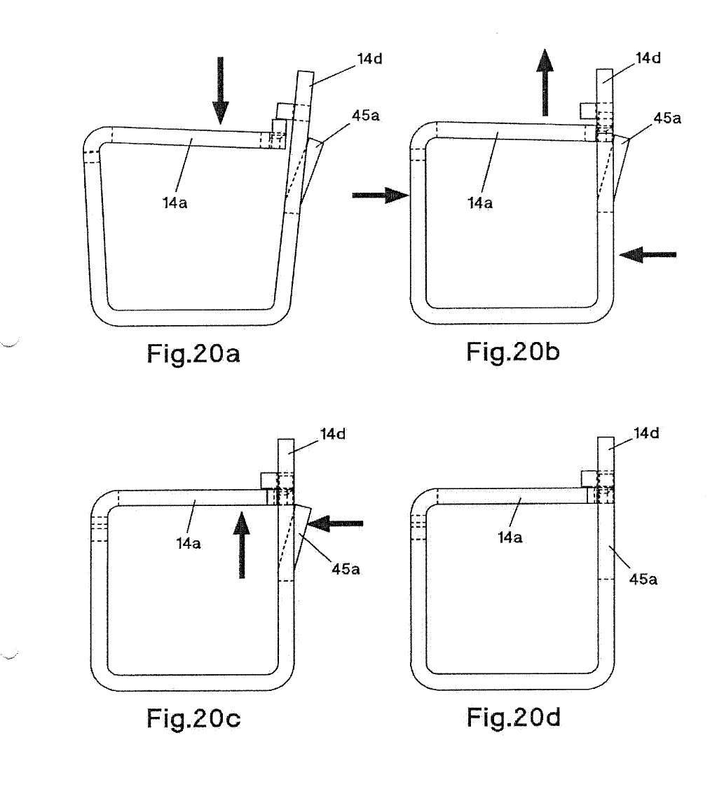

FIG. 20: schematic view of the plug-on part according to the fourth embodiment;

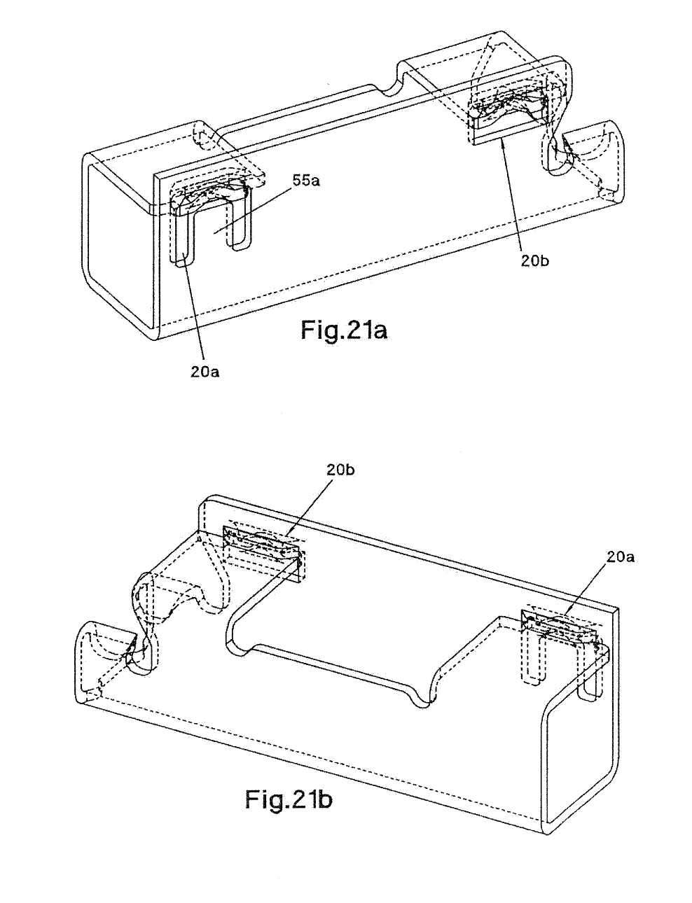

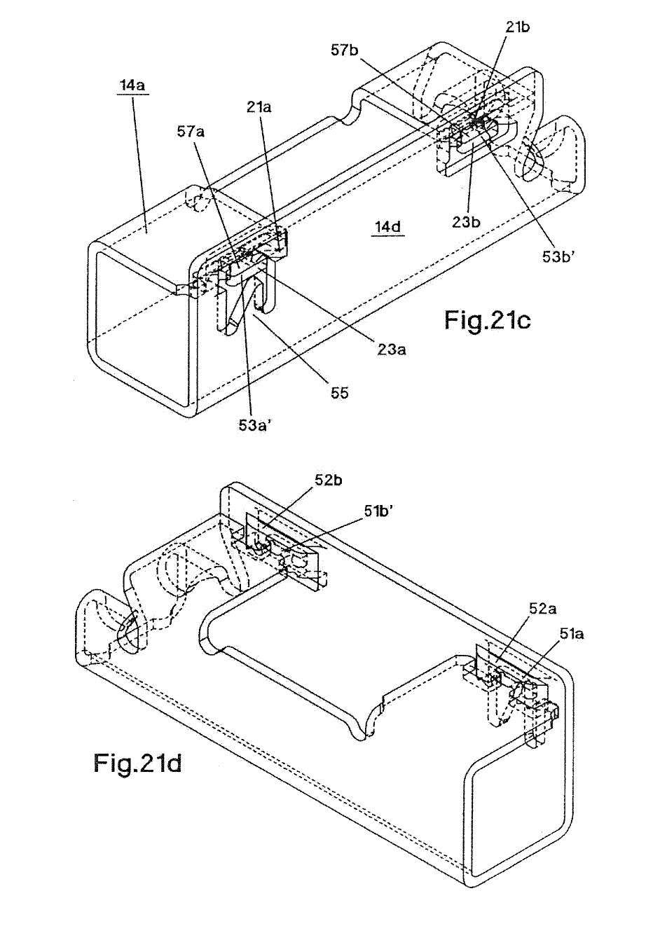

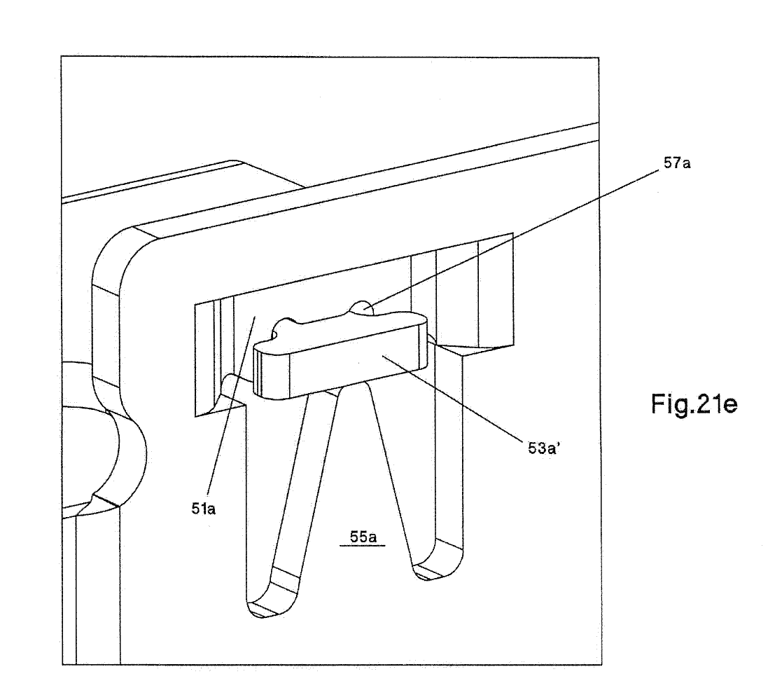

FIG. 21: perspective views of a fifth embodiment of a plug-on part for a plug connector;

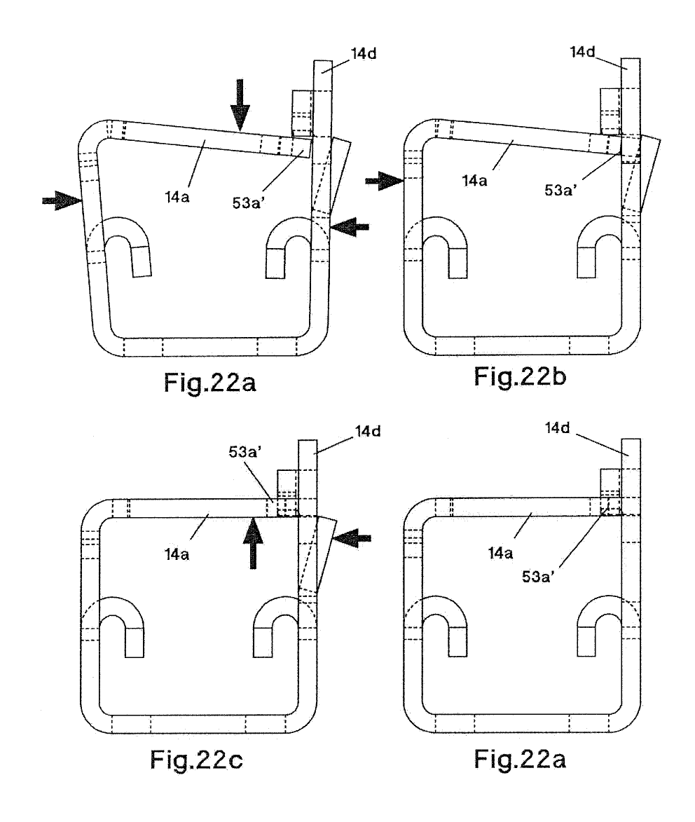

FIG. 22: schematic view of the manufacturing process of the plug-on part according to the fifth embodiment;

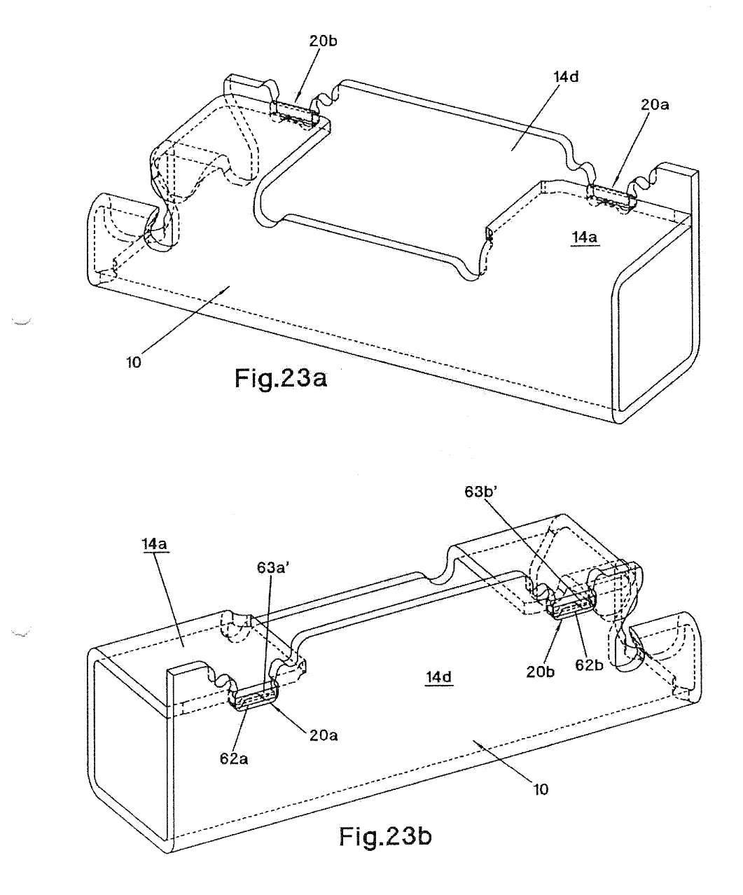

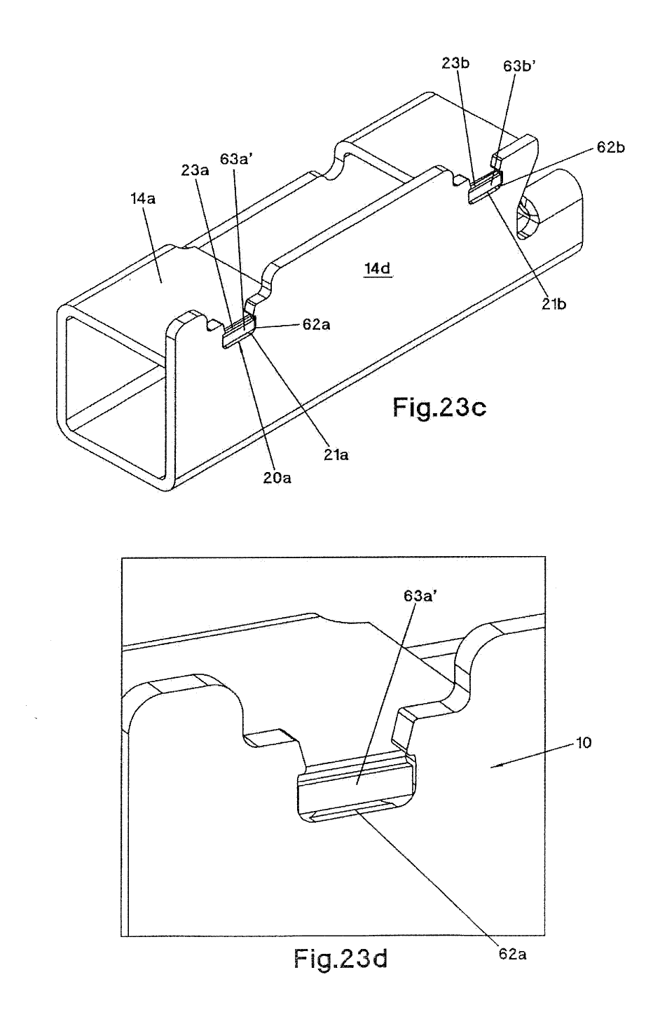

FIG. 23: perspective views of a sixth embodiment of a plug-on part for a plug connector;

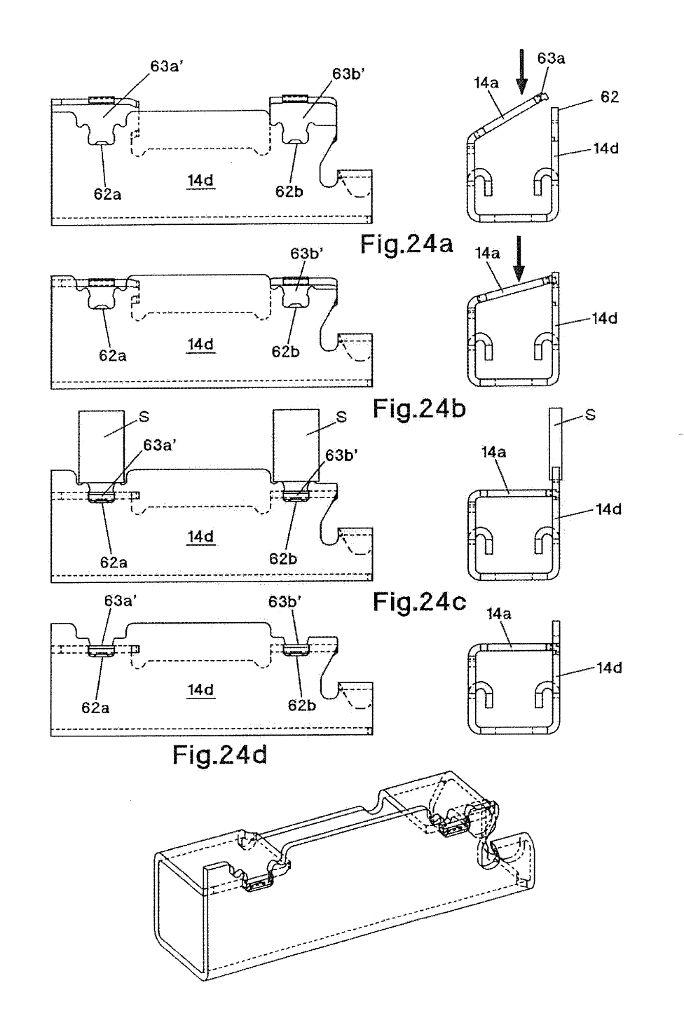

FIG. 24: schematic view of the manufacturing process of the plug-on part according to the sixth embodiment;

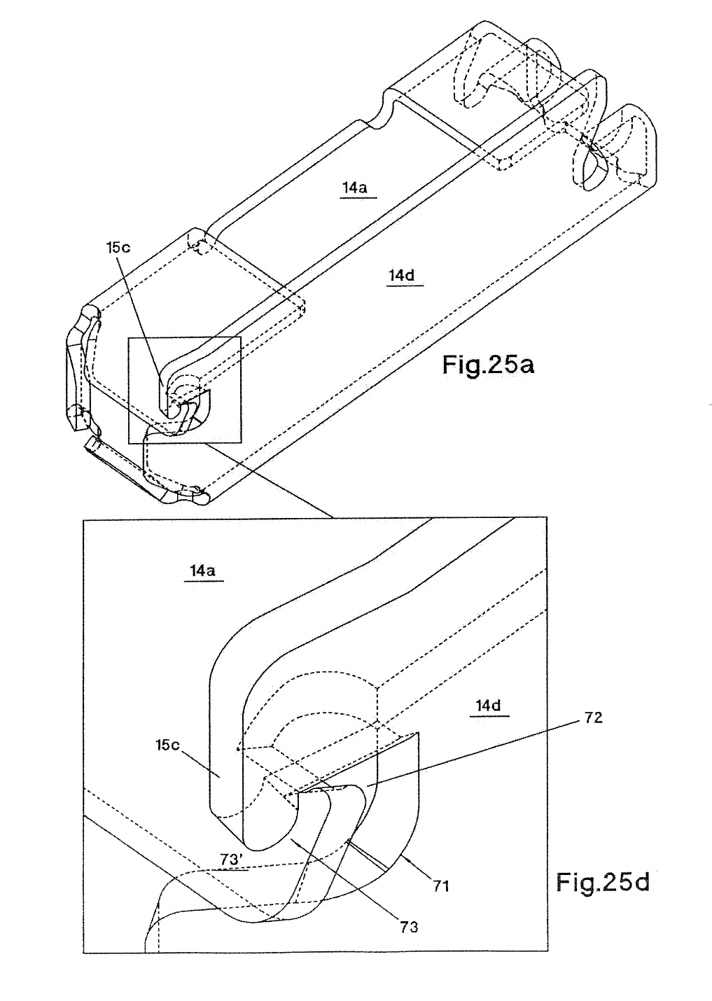

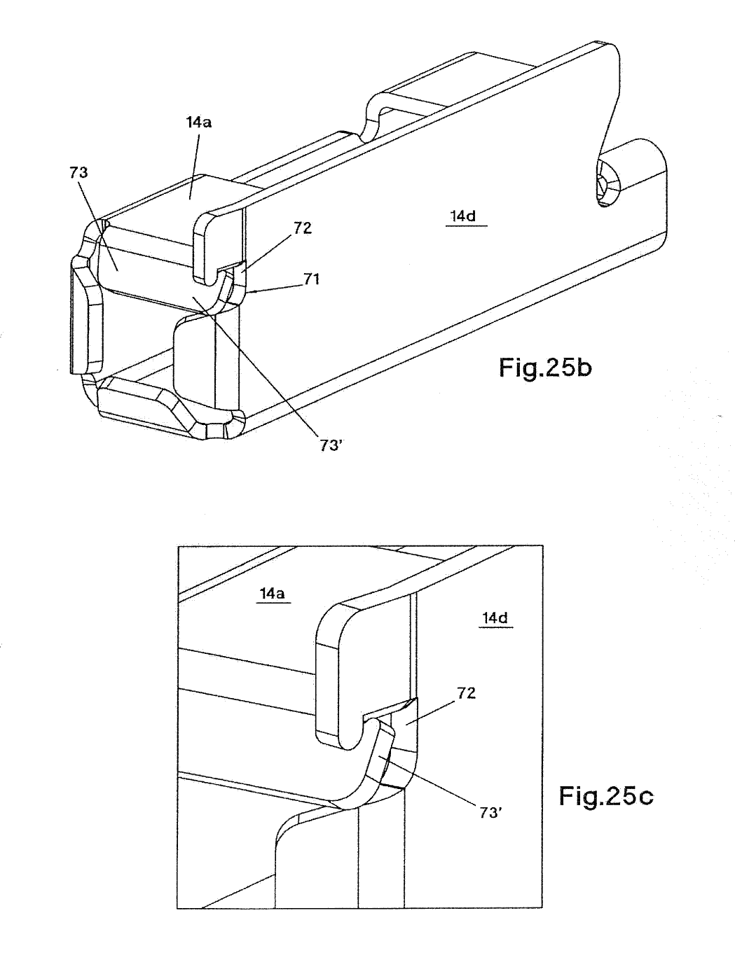

FIG. 25: perspective view of a seventh embodiment of a plug-on part for a plug connector; and

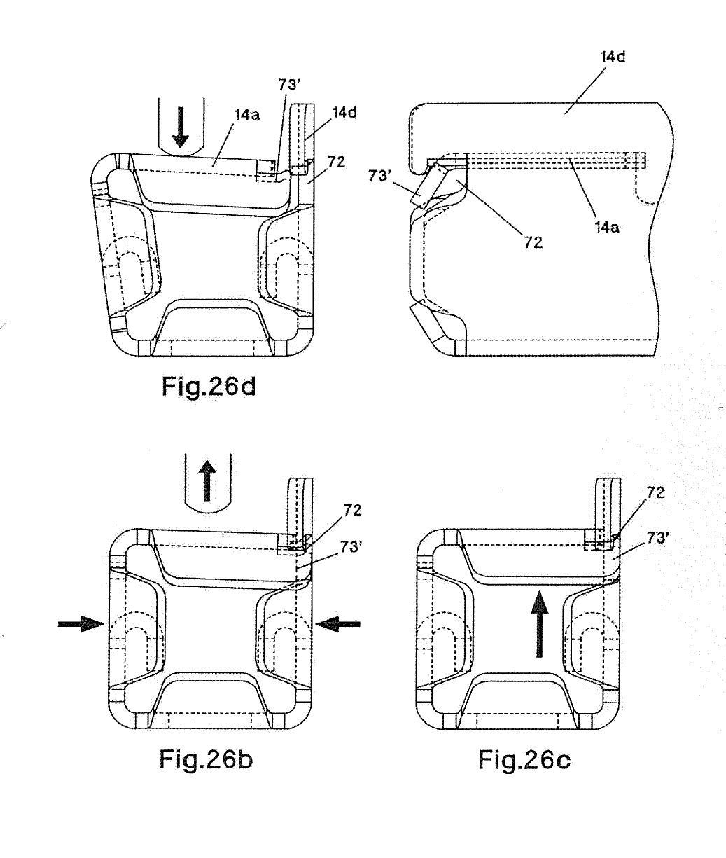

FIG. 26: schematic view for manufacturing of the plug-on part according to the seventh embodiment.

FIG. 1 shows several perspective views of an electrical plug connector 1, which basically can be divided in a connecting element 2 for receiving a contact element of a plug connector complementary to the shown plug connector 1 and a crimping element 3. The latter has two crimp flaps 4 and 5, which are in principle known and are therefore not described in more detail, the crimp flaps serve for connecting a conducting wire and its insulation. A transition region 6 connects the connecting element 2 and the crimp element 3. Such a plug connector is known and is therefore not described in more detail. It is apparent for the skilled person from the following description that the detailed structure of the plug connector is only of minor importance for understanding the invention which is described in more detail in the following.

A plug-on part 10 is pushed over the connecting element 2 which is shown as a first embodiment in FIGS. 2 to 5. The plug-on part 10 comprises a sleeve-like basic body 11 into which the connecting element 2 of the plug connector 1 is pushable through a first opening 11a. Through a second opening 11b of the sleeve-like basic body 11 of the plug-on part 10 the contact element of the before mentioned but not shown complementary plug connector can be inserted. At one side of the basic body 11 which is opposite to the opening 11b, the basic body 11 comprises two fixing elements 12a, 12b by which the plug-on part 10 is fixable at the plug connector 1. Such a structure is known and and is therefore not described in more detail.

In the shown embodiments the sleeve-like basic body 11 comprises a rectangular cross-section. It is apparent for the skilled person from the following description that the rectangular cross-section is not mandatory. In fact a triangular cross-section or a polygonal cross-section of the basic body 11 is possible as well as a round, oval or curved cross-section, to name just a few examples.

The basic body 11 is manufactured from a strip of material 13 by deforming the strip of material 13 to form the sleeve-like basic body 11 by corresponding bending operations; the sleeve-like basic body 11 comprises—as best seen from FIG. 4—a top surface 14a, a bottom surface 14b and two side surfaces 14c and 14d. As best seen from FIG. 6a, the two longitudinal edges 15a and 15b are adjacent to each other in this state of bending of the strip of material 13. The two longitudinal edges 15a and 15b need to be connected to each other to form the closed basic body 11 of the plug-on part 10.

The manner by which the two longitudinal edges 15a and 15b of the strip of material 13 are connected to each other is essential, as shown in this first embodiment. As already mentioned before, the connection of the longitudinal edges for known plug-on parts is performed by welding, in particular by laser welding, which is investment-consuming and production cost-consuming. The shown embodiment provides that the two longitudinal edges 15a, 15b of the strip of material 13 are mechanically connected, by providing—in the described embodiment there are two—mechanical connections 20a and 20b. For this a surface having the first longitudinal edge 15a—here side surface 14d—comprises two locking elements 21a, 21b and the surface having the second longitudinal edge 15b—here top surface 14a—comprises locking elements 23a, 23b complementary to and cooperative with the before mentioned locking elements 21a, 21b. By the cooperating locking elements 21a, 23a and 21b, 23b, respectively—as described below—the longitudinal edges 15a, 15b of the strip of material 13 are fixed in position to each other thus forming a stable sleeve-like basic body 11.

In the first embodiment of the plug-on part 10, the locking elements 21a, 21b forming the mechanical connections 20a, 20b are formed as latching elements 21a′ and 21b′ each having a latching opening 22a′ and 22b′. The top surface 14a of the sleeve-like basic body 11 comprises as complementary locking element 23a, 23b two latching elements 23a′ and 23b′, which are formed to engage the latching openings 22a′ and 22b′ in the locked state. For this it is provided that under the latching elements 21a′ and 21b′ of the side surface 14d, as particularly shown in FIG. 1d, inlet openings 25a, 25b are provided, through which the latching elements 23a′, 23b′ can be positioned, whereas the latching elements 23a′, 23b′ project upwards from top surface 14a and thus can be positioned under the latching openings 22a′, 22b′ of the latching elements 21a′, 21b′, as described in the following.

The manufacturing of the sleeve-like basic body 11 is described according to FIGS. 6a to 6d. FIG. 6a shows the strip of material 13 before the locking process. It can be seen that the longitudinal edges 15a, 15b of the strip of material 13 are not connected yet. As can be seen from FIG. 6d, the top surface 14a is pushed downward by a die S until the latching elements 23a′ and 23b′ are lying below the latching elements 21a′ and 21b′ of the side surface 14d. Then, by sideways impingement of the pre-basic body its width dimension is adjusted. This causes the latching elements 23a′, 23b′ of the top surface 14a to enter the inlet openings 25a, 25b of the side surface 14d and thus being positioned below the latching openings 22a′, 22b′ of the latching elements 21a′, 21b′ of the side surface 14d. A backward movement of die S causes the top surface 14a to flexibly move back—as can be seen in FIG. 6c—so that the latching elements 23a′, 23b′ of the top surface 14a move into the latching openings 22a′, 22b′ of the latching elements 21a′, 21b′ of the side surface 14d. Hereby the locking of the top surface 14a with the side surface 14d can be achieved, so that a stable sleeve-like basic body 11 of the plug-on part 10 is formed.

As soon as this basic body 11—as shown in FIG. 6d—is pushed over the connecting element 2 of the plug connector 1, this causes the front portion of the connecting element 2 to prevent an unintentional lowering of the top surface 14a, as it butts against the latter and thus forms a stopper.

FIGS. 7 to 11 show a second embodiment of a plug-on part 10 which corresponds to the first embodiment in its basic structure, so that corresponding parts have the same reference signs and are therefore not described in more detail. The significant difference between the first and second embodiment is the forming of the connections 20a, 20b. In the second embodiment it is provided that the locking elements 21a, 21b of the side surface 14d are formed as shear elements 31a, 31b, particularly as shear noses.

For this the top surface 14a comprises projections 33a′, 33b′ having openings 33a′, 33b′ as locking elements 23a, 23b instead of latching elements 23a′ and 23b′—as can be best seen from FIGS. 8 and 9, as well as from FIG. 11—into which the shear noses 31a, 31b, corresponding to the latching elements 21a′, 21b′ of the first embodiment, immerse and thereby connecting the top surface 14a with the side surface 14d for forming a sleeve-like basic body 11.

The manufacturing process of the basic body 11 from the strip of material 13 is now described according to FIGS. 12a-12d. FIG. 12a shows the strip of material 13 with yet not connected longitudinal edges 15a, 15b. Then—likewise as in the first embodiment—by means of a die S the top surface 14a is pushed downward until it lies below the shear noses 31a, 31b. As can be seen from FIG. 12b, then by a sideways impingement of the two side surfaces 14c and 14d the width dimension of the basic body 11 is adjusted. This causes the projections 33a, 33b projecting from the top surface 14a towards the side surface 14d, to engage with the inlet openings 25a, 25b of the side surface 14d, the openings 33a′, 33b′ of the top surface 14a come to a rest below the shear noses 31a, 31b. After a backward movement of die S, the top surface 14a flexibly moves upwards and abuts the shear noses 31a, 31 b—as can be seen from FIG. 12c. By means of a further die S1 the shear noses 31a, 31b are bent downwards and thus immerse into the openings 33a, 33b of the top surface 14a—as can be seen from FIG. 12d.

FIGS. 13 to 17 show a third embodiment of a plug-on part 10, whereas as before corresponding parts have the same reference signs and are therefore not described in more detail. The significant difference between the third embodiment and the first two embodiments is that the locking elements 21a, 21b of the side surface 14d are formed as shear flaps 41a, 41b and the locking elements 23a, 23b of the top surface 14a are formed as projections 43a, 43b having notches 43a′, 43b′.

The manufacturing process of the basic body 11 is now described according to FIGS. 18a to 18c. FIG. 18a shows the strip of material 13 as described in FIGS. 6a and 12a. As shown in FIG. 18b, the top surface 14a is impinged by a die S until it lies underneath the shear flaps 41a, 41b of the side surface 14d. By a sideways impingement of the basic body 11 its width dimension is adjusted, which causes the projections 43a, 43b to enter the inlet openings 25a, 25b of the side surface 14d and the notches 43a′, 43b′ come to a rest below the shear flaps 41a,41 b. After a backward movement of die S the top surface 14a flexibly moves upwards and the shear flaps 41a, 41b engage the notches 43a′, 43b′ of the top surface 14a and thus lock the top surface 14a with the side surface 14d—as can be seen from FIG. 18c.

FIG. 19 shows a fourth embodiment of the plug-on part 10 for a plug connector in perspective views, whereas corresponding parts have the same reference signs and are therefore not described in more detail. In the here described case the locking elements 21a, 21b and 23a, 23b are formed as described in the first embodiment, so that they are not described in detail. The significant difference between the first and fourth embodiment is—as can be best seen from FIG. 18a—that a fixing element 45a is arranged in the inlet opening 25a of side surface 14d serving to secure the mechanical connection 20a, formed as in the first embodiment by cooperative locking elements 21a, 23a, against unintentional loosening. Such a configuration is particularly advantageous for the case the connecting element 2 pushed into the basic body 11 is significantly smaller as the inner dimensions of the sleeve-like basic body 11, so that this connecting element 2 of the plug connector 1—as in the first embodiment—can no longer prevent an unintended lowering of the top surface 14a by abutting the latter and thus forming a stopper.

The manufacturing of the sleeve-like basic body 11 is now described according to FIGS. 20a-20d. FIG. 19a shows the strip of material 13 before the locking process. It can be seen, that the longitudinal edges 15a, 15b are not yet connected. The top surface 14a is again pushed downward until the latching elements 43a′, 43b′ lie underneath the latching elements 41a′, 41b′. Then, as can be seen from FIG. 19b, the width dimension is adjusted causing the locking elements 21a, 21b of the top surface 14a to enter the inlet openings 25a, 25b of the side surface 14d and thus lie below the latching openings 42a′, 42b′ of the latching elements 41a′, 41b′. By a flexible backward movement of the top surface 14a or by a mechanical impingement of the same an effective engagement between the locking elements 21a and 23a as well as 21b and 23b is formed. Then, as can be seen from FIG. 20c, the fixing element 45a is impinged causing its move under the locking element 23a of the top surface 14a and thus forming a stopper, which prevents the locking element 23a moving backward unintentionally. The mechanical connection 20a of the fourth embodiment distinguishes itself by a particularly high closure security.

FIGS. 21 to 22 show a fifth embodiment of a plug-on part 10 for a plug connector 1, corresponding in its basic structure to the fourth embodiment, so that corresponding parts have the same reference signs and are therefore not described in more detail. The significant difference between the two before mentioned embodiments is the configuration of the locking elements 21a, 21b and 23a, 23b. As can be seen best from FIG. 21d, the projections 53a′, 53b′ of the locking elements 23a, 23b of the top surface 14a are formed to be hammer-like. The latching projections 51a′, 51b′ having the latching openings 52a, 52b each comprise at its underside a latching opening 57a, 57b into which the inner lying thinner part of the latching elements 51a′, 51b′ can enter, as shown in FIG. 21c. The fixing element 55b corresponding to fixing element 45a has a triangular form.

The manufacturing of the plug-on part 10 is now described according to FIGS. 22a to 22d. It basically corresponds to the fourth embodiment including the before described measure that the latching elements 51a′, 51b′ enter into the latching openings 57a, 57b of the locking elements 23a, 23b.

In FIGS. 23 and 24 a sixth embodiment of a plug-on part 10 is now described, whereas corresponding parts have the same reference signs and are therefore not described in more detail.

Again, the significant difference between this embodiment and the ones described before lies in the configuration of the mechanical connections 20a, 20b. As can be best seen from FIGS. 23a and 23c, the locking elements 21a, 21b of the side surface 14d is formed as latching openings 62a, 62b into which the here as latching projections 63a′, 63b′ formed locking elements 23a, 23b of the top surface 14 can enter. The outer contour of the latching projections 63a′, 63b′ is such aligned to the contour of the latching openings 62a, 62b of the locking elements 21a, 21b that the latching projections 63a′, 63b′ are pressed into the latching openings 62a, 62b being preloaded and thus lock the two longitudinal edges 15a, 15b to each other.

The manufacturing process of the plug-on part 10 is now described according to FIGS. 24a to 24d, whereas the left drawing of each Figure shows a side view and the right drawing shows a front view of the basic body 11. As can be seen from FIG. 24a, firstly, the top surface 14a is pushed downwards until its locking elements 23a, 23b lie above the locking elements 21a, 21b of the side surface 14d. Then, as can be seen from FIG. 24b, the width dimension is adjusted, causing the latching projections 63a′, 63b′ of the locking elements 23a, 23b to lie above the latching openings 62a, 62b of the locking elements 21a, 21b. By a further impingement of the top surface 14d the latching projections 63a′, 63b′ are pressed into the latching openings 62a, 62b and then—as shown in FIG. 24c—are impinged by means of a die for forming a latching connection extending there through. FIG. 24d shows the finished plug-on part.

FIGS. 25 and 26 shows a seventh embodiment of a plug-on part 10 for a plug connector 1, which distinguishes itself by a particularly simple mechanical structure and thus simple manufacturing. Contrary to the before mentioned embodiments the locking elements 71 and 73 are arranged at a transverse edge 15c of the side surface 14a and the top surface 14d. The locking element 71 of the side surface 14d is formed as latching opening 72 and the locking element 73 of the top surface 14a is formed as a latching projection 71′. The manufacturing of the plug-on part 10 is now described by means of FIGS. 26a to 26b. As can be seen from FIG. 26a, the top surface 14a is impinged until the latching projection 73′ lies underneath the latching opening 72. By adjustment of the width dimension and a downward bending of the latching projection 73′ the mechanical connection 20 is formed.

In the before mentioned description it has been assumed that at least the top surface 14a of the strip of material 13 is elastically resilient, so that it can move backward by its own tension against the moving direction of the die S, as soon as the effective engagement with the latter has been released. This has the advantage, that hereby the locking elements 21a, 21b and 71, respectively, are automatically in effective contact with the complementary locking elements 23a, 23b and 73, respectively. However, this is not mandatory. For example, it is possible that the top surface 14a is non-resilient, so that in this case the effective engagement between the locking elements 21a, 21b, 71 and locking elements 23a, 23b and 73 of the side surface 14d is effective by an impingement of the top surface 14a in a moving direction against that of die S. Advantageously, a forming of the plug-on part 10 is favored where at least the top surface 14a is resilient.

To summarize, it shall be noted that the described measures form a plug-on part 10 for a plug connector 1, the plug-on part 10 distinguishes itself by a simple mechanical structure. The connection of the surface having the first longitudinal edge 15a—side surface 14d—with the surface having the second longitudinal edge 15b—top surface 14a—for forming the sleeve-like basic body 11 of the plug-on part 10 is performed by simple mechanical connections, so that a complex laser welding of the longitudinal edges 15a and 15b is not necessary. Thus, the described plug-on part 10 distinguishes itself by its simple and cost-effective manufacturing.

1-11. (canceled)

12. A plug-on part for a plug connector, comprising
a sleeve-like basic body manufactured by deforming a strip of material having two longitudinal edges and two transverse edges and by connecting the longitudinal edges, wherein
a surface of the strip of material having the first longitudinal edge comprises at least a first locking element and a further surface of the strip of material having the second longitudinal edge comprises a further locking element complementary to the first locking element; and
the connection of the longitudinal edges of the strip of material to form the sleeve-like basic body is performed by cooperating locking elements.

13. The Plug-on part according to claim 12, wherein the surface of the strip of material strip having the first longitudinal edge comprises as first locking element at least one latching element, and the further surface having the second longitudinal edge comprises as further locking element at least one complementary latching element which is complementary to said latching element.

14. The plug-on part according to claim 13, wherein the first latching element is a latching projection having a latching opening and the complementary latching element is a further latching projection engaging the corresponding latching opening to form a mechanical connection.

15. The plug-on part according to claim 12, wherein the first locking element is a shear nose and the complementary locking element is an opening in the corresponding surface of the strip of material.

16. The plug-on part according to claim 12, wherein the first locking element is a shear flap and the thereto complementary locking element is a notch.

17. The plug-on part according to claim 12, wherein below at least one first locking element there is arranged an entry opening for the further locking element which cooperates with the first locking element.

18. The plug-on part according to claim 12, wherein the first locking element is formed as a latching opening in the thereto corresponding surface and the further locking element cooperates with said first locking element and is formed as a latching projection which can be pressed into said latching opening.

19. The plug-on part according to claim 12, wherein at least one fixing element is provided, which impinges the further locking element in its locked state.

20. The plug-on part according to claim 12, wherein the first locking element and the second locking element is arranged at a transverse edge of the strip of material.

21. The plug-on part according to claim 12, wherein the first locking element is formed as a latching projection and the further locking element is formed as a latching opening, and the latching projection can be bent into the latching opening.

22. The plug-on part according to clam 12, wherein at least one surface of the strip of material is resilient.
